(19) United States
(12) Patent Application Publication
(10) Pub. No.: US 2026/0247292 A1
(43) Pub. Date: Aug. 20, 2026

(54) POWER CONTROL FOR SRS TRANSMISSION USED FOR NON-CODEBOOK BASED UL TRANSMISSION

(71) Applicant: Lenovo (Beijing) Limited, Beijing (CN)

(72) Inventors: Bingchao Liu, Beijing (CN); Chenxi Zhu, Fairfax, VA (US); Lingling Xiao, Beijing (CN); Wei Ling, Beijing (CN); Yi Zhang, Beijing (CN)

(73) Assignee: Lenovo (Beijing) Limited, Beijing (CN)

(21) Appl. No.: 19/134,567

(22) PCT Filed: Dec. 29, 2022
(86) PCT No.: PCT/CN2022/143200

§ 371 Date: May 30, 2025

(51) Int. Cl. H04W 52/14; H04B 7/06

(52) U.S. Cl. CPC H04W 52/146; H04B 7/0626

(57) ABSTRACT

Method and apparatus for power control for SRS transmission used for non-codebook based UL transmission are disclosed. In one embodiment, a UE comprises a transceiver; and a processor coupled to the transceiver, wherein, a TCI state is indicated for a BWP of a serving cell, and wherein the processor is configured to determine, based on a PL-RS associated with the indicated TCI state for the BWP of the serving cell, RS index q_{d} for obtaining the downlink pathloss estimate for SRS transmission corresponding to SRS resource set for non-codebook configured with an associated NZP CSI-RS resource; and obtain values of P_{O_SRS,f,c}(qs), α_{SRS,b,f,c}(qs), and SRS power control adjustment state 1 for the SRS transmission corresponding to the SRS resource set resource set for non-codebook configured with the associated NZP CSI-RS resource from a set of power control parameters for SRS including P0, alpha and closed loop index 1 in an uplink power control parameter set, wherein, the uplink power control parameter set is one of: (1) the uplink power control parameter set associated with the indicated TCI state; (2) a dedicated uplink power control parameter set configured for the BWP of the serving cell; and (3) an uplink power control parameter set in a uplink power control parameter set list configured for the serving cell with the lowest set ID.

### FIELD

The subject matter disclosed herein generally relates to wireless communications, and more particularly relates to methods and apparatuses for power control for SRS transmission used for non-codebook based UL transmission.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), User Entity/Equipment (Mobile Terminal), Transmitter (TX), Receiver (RX), non-codebook (nCB), transmission configuration indication (TCI), Sounding Reference Signal (SRS), Channel State Information Reference Signal (CSI-RS), non-zero power (NZP), Physical Uplink Shared Channel (PUSCH), path loss reference signal (PL-RS), Bandwidth part (BWP), Downlink Control Information (DCI), medium access control (MAC), control element (CE), Radio Resource Control (RRC), Physical Uplink Control Channel (PUCCH), The 3rd Generation Partnership Project (3GPP), Technical Specification (TS).

Non-codebook (nCB) based UL transmission is supported with unified TCI framework in NR Release 17. To support nCB based UL transmission, one or more SRS resource sets (each includes one or more SRS resources) used for non-codebook can be configured for a UE in a BWP of a serving cell. Each of the SRS resource sets can be associated with a configured NZP CSI-RS resource to calculate the precoder for the SRS transmissions for the gNB to select proper UL precoder for the subsequent PUSCH transmission. Further, each SRS resource (of each SRS resource set) can be configured with a TCI state to determine the UL TX spatial filter, i.e., the UL beam, for the SRS transmission. Each TCI state is associated with a PL-RS as well as a set of power control parameters for the UE to determine the transmit power for the SRS transmission. With unified TCI framework, a unified TCI state can be indicated for a BWP of a serving cell by a DCI or a MAC CE or RRC signaling for all the PUSCH and PUCCH transmission in the BWP of the serving cell. An SRS resource set can also be configured to follow the indicated unified TCI state by RRC signaling when the SRS resource set is not configured with a TCI state. If a SRS resource is configured with a TCI state or is indicated to follow the indicated unified TCI state, the UE shall transmit the SRS with the power determined by the power control parameters associated with the TCI state (or the indicated unified TCI state). However, when the SRS resource set is configured with an associated NZP CSI-RS, the UE shall not expect to be configured with a TCI state or be indicated to follow the indicated unified TCI state to avoid the RX and TX beam misalignment. In addition, the associated NZP CSI-RS cannot be used as the PL-RS when it has more than two ports since it will increase the UE complexity. In addition, it is unknown how to determine the other power control parameters including P0, alpha, and closed loop index.

This disclosure targets the above issues.

### BRIEF SUMMARY

Method and apparatus for power control for SRS transmission used for non-codebook based UL transmission are disclosed.

In one embodiment, a UE comprises a transceiver; and a processor coupled to the transceiver, wherein, a TCI state is indicated for a BWP of a serving cell, and wherein the processor is configured to determine, based on a PL-RS associated with the indicated TCI state for the BWP of the serving cell, RS index q_{d} for obtaining the downlink pathloss estimate for SRS transmission corresponding to SRS resource set for non-codebook configured with an associated NZP CSI-RS resource; and obtain values of P_{O_SRS,f,c}(qₛ), α_{SRS,b,f,c}(qₛ), and SRS power control adjustment state l for the SRS transmission corresponding to the SRS resource set for non-codebook configured with the associated NZP CSI-RS resource from a set of power control parameters for SRS including P0, alpha and closed loop index/in an uplink power control parameter set, wherein, the uplink power control parameter set is one of: (1) the uplink power control parameter set associated with the indicated TCI state; (2) a dedicated uplink power control parameter set configured for the BWP of the serving cell; and (3) an uplink power control parameter set in a uplink power control parameter set list configured for the serving cell with the lowest set ID.

In some embodiment, two TCI states including a first TCI state and a second TCI state are indicated for the BWP of the serving cell, and wherein, the processor is configured to determine, based on a PL-RS associated with the first indicated TCI state for the BWP of the serving cell, RS index q_{d} for obtaining the downlink pathloss estimate for SRS transmission corresponding to a first SRS resource set for non-codebook configured with a first associated NZP CSI-RS resource, and determine, based on a PL-RS associated with the second indicated TCI state for the BWP of the serving cell, RS index q_{d} for obtaining the downlink pathloss estimate for SRS transmission corresponding to a second SRS resource set for non-codebook configured with a second associated NZP CSI-RS resource; and obtain values of P_{O_SRS,f,c}(qₛ), α_{SRS,b,f,c}(qₛ), and SRS power control adjustment state l for the SRS transmission corresponding to the first SRS resource set for non-codebook configured with the first associated NZP CSI-RS resource from a first set of power control parameters for SRS including P0, alpha and closed loop index l in a first uplink power control parameter set, and obtain values of P_{O_SRS,f,c}(qₛ), α_{SRS,b,f,c}(qₛ), and SRS power control adjustment state l for the SRS transmission corresponding to the second SRS resource set for non-codebook configured with the second associated NZP CSI-RS resource from a second set of power control parameters for SRS including P0, alpha and closed loop index l in a second uplink power control parameter set, wherein, the first uplink power control parameter set and the second uplink power control parameter set are one of: (1) the uplink power control parameter set associated with the first indicated TCI state and the uplink power control parameter set associated with the second indicated TCI state; (2) a first dedicated uplink power control parameter set configured for the BWP of the serving cell and a second dedicated uplink power control parameter set configured for the BWP of the serving cell; (3) an uplink power control parameter set in a first uplink power control parameter set list configured for the serving cell with the lowest set ID and an uplink power control parameter set in a second uplink power control parameter set list configured for the serving cell with the lowest set ID; and (4) an uplink power control parameter set in an uplink power control parameter set list configured for the serving cell with the lowest set ID and an uplink power control parameter set in the uplink power control parameter set list configured for the serving cell with the second lowest set ID.

In some embodiment, two TCI states each of which is associated with a coresetPoolIndex value are indicated for the BWP of the serving cell, and wherein, the processor is configured to determine RS index q_{d} for obtaining the downlink pathloss estimate for SRS transmission corresponding to a first SRS resource set for non-codebook configured with a first associated NZP CSI-RS resource, based on a PL-RS associated with one indicated TCI state associated with the same coresetPoolIndex value as that associated with the first SRS resource set for non-codebook, and determine RS index q_{d} for obtaining the downlink pathloss estimate for SRS transmission corresponding to a second SRS resource set for non-codebook configured with a second associated NZP CSI-RS resource, based on a PL-RS associated with one indicated TCI state associated with the same coresetPoolIndex value as that associated with the second SRS resource set for non-codebook; and obtain values of P_{O_SRS,f,c}(s), α_{SRS,b,f,c}(s), and SRS power control adjustment state l for the SRS transmission corresponding to the first SRS resource set for non-codebook configured with the first associated NZP CSI-RS resource from a first set of power control parameters for SRS including P0, alpha and closed loop index l in a first uplink power control parameter set, and obtain values of P_{O_SRS,f,c}(qₛ), α_{SRS,b,f,c}(s), and SRS power control adjustment state l for the SRS transmission corresponding to the second SRS resource set for non-codebook configured with the second associated NZP CSI-RS resource from a second set of power control parameters for SRS including P0, alpha and closed loop index l in a second uplink power control parameter set, wherein, the first uplink power control parameter set and the second uplink power control parameter set are one of: (1) the uplink power control parameter set associated with one indicated TCI state that is associated with the same coresetPoolIndex value as that associated with the first SRS resource set and the uplink power control parameter set associated with one indicated TCI state that is associated with the same coresetPoolIndex value as that associated with the second SRS resource set; (2) a first dedicated uplink power control parameter set configured for the BWP of the serving cell associated with the same coresetPoolIndex value as that associated with the first SRS resource set and a second dedicated uplink power control parameter set configured for the BWP of the serving cell associated with the same coresetPoolIndex value as that associated with the second SRS resource set; (3) an uplink power control parameter set in a first uplink power control parameter set list configured for the serving cell that is associated with the same coresetPoolIndex value as that associated with the first SRS resource set with the lowest set ID and an uplink power control parameter set in a second uplink power control parameter set list configured for the serving cell that is associated with the same coresetPoolIndex value as that associated with the second SRS resource set with the lowest set ID; and (4) an uplink power control parameter set in an uplink power control parameter set list configured for the serving cell with the lowest set ID and an uplink power control parameter set in the uplink power control parameter set list configured for the serving cell with the second lowest set ID.

In another embodiment, a method is performed at a UE, wherein, a TCI state is indicated for a BWP of a serving cell, the method comprises determining, based on a PL-RS associated with the indicated TCI state for the BWP of the serving cell, RS index q_{d} for obtaining the downlink pathloss estimate for SRS transmission corresponding to SRS resource set for non-codebook configured with an associated NZP CSI-RS resource; and obtaining values of P_{O_SRS,f,c}(s), α_{SRS,b,f,c}(s), and SRS power control adjustment state l for the SRS transmission corresponding to the SRS resource set for non-codebook configured with the associated NZP CSI-RS resource from a set of power control parameters for SRS including P0, alpha and closed loop index l in an uplink power control parameter set, wherein, the uplink power control parameter set is one of: (1) the uplink power control parameter set associated with the indicated TCI state; (2) a dedicated uplink power control parameter set configured for the BWP of the serving cell; and (3) an uplink power control parameter set in a uplink power control parameter set list configured for the serving cell with the lowest set ID.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 is a schematic flow chart diagram illustrating an embodiment of a method; and

FIG. 2 is a schematic block diagram illustrating apparatuses according to one embodiment.

### DETAILED DESCRIPTION

As will be appreciated by one skilled in the art that certain aspects of the embodiments may be embodied as a system, apparatus, method, or program product.

Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

A first embodiment relates to single-TRP scenario.

In single-TRP scenario, UE is indicated with one unified TCI state. As specified in 3GPP TS 38.213, the indicated unified TCI state, which can be a joint TCI state that is used for both UL transmission and DL reception, or a UL TCI state that is dedicated for UL transmission, for a BWP of a serving cell is associated with (or includes) a PL-RS for the UE to obtain the downlink pathloss estimation for the PUSCH, PUCCH and SRS transmission. The obtained downlink pathloss estimation can be used for the SRS transmission for non-codebook configured with an associated NZP CSI-RS resource. It means that the UE determines RS index q_{d} for obtaining the downlink pathloss estimate for SRS transmission based on the PL-RS associated with or included in the indicated unified TCI state.

The other power control parameters including P0 (which configures the target receiving power at the TRP side), a (which is the partial pathloss compensation factor) and closed loop index (or power control adjustment state) l can be obtained in the following manner.

Multiple uplink power control parameter sets (e.g., ul-powerControls), each of which has a power control parameter set identity (e.g., ul-powerControl-Id) may be configured for the serving cell. Each uplink power control parameter set includes a power control parameter set for PUSCH (e.g., p0AlphaSetforPUSCH), a power control parameter set for PUCCH (e.g., p0AlphaSetforPUCCH), and a power control parameter set for SRS (e.g., p0AlphaSetforSRS). Each of p0AlphaSetforPUSCH, p0AlphaSetforPUCCH and p0AlphaSetforSRS contains one set of P0, α and l. One of the multiple uplink power control parameter sets, i.e., a ul-powerControl, may be associated with the indicated unified TCI state. In this condition, the power control parameter set for SRS (e.g., p0AlphaSetforSRS) in the uplink power control parameter set associated with the indicated unified TCI state can be used for the SRS transmission for nCB configured with the associated NZP CSI-RS resource. It means that the value of P_{O_SRS,f,c}(qₛ), α_{SRS,b,f,c}(qₛ), and SRS power control adjustment state l, which are used for the UE to calculate the transmit power, for the SRS transmission corresponding to the SRS resource set for non-codebook configured with the associated NZP CSI-RS resource are obtained from a power control parameter set for SRS associated with the indicated unified TCI state, where the power control parameter set for SRS includes P0, α and closed loop index l for SRS. Accordingly, if a power control parameter set for SRS (e.g., p0AlphaSetforSRS) is associated with the indicated unified TCI state, the values of P_{O_SRS,f,c}(qₛ), α_{SRS,b,f,c}(qₛ), and l are provided by p0AlphaSetforSRS associated with the indicated unified TCI state.

If ul-powerControl is not associated with the indicated unified TCI state, a default ul-powerControl should be determined. The following options can be considered.

Option 1-1: if only one dedicated ul-powerControl is configured for the BWP of the serving cell and no ul-powerControl list is configured in the serving cell, the values of P_{O_SRS,f,c}(qₛ), α_{SRS,b,f,c}(qₛ), and l are provided by the p0AlphaSetforSRS in the dedicated ul-powerControl configured for the BWP of the serving cell.

Option 1-2: If an uplink power control parameter set list (e.g., ul-powerControl list) is configured in the serving cell and the dedicated ul-powerControl is not configured for the BWP of the serving cell, the values of P_{O_SRS,f,c}(qₛ), α_{SRS,b,f,c}(qₛ), and l are provided by p0AlphaSetforSRS in the ul-powerControl in the uplink power control parameter set list configured in the serving cell with the lowest set ID (e.g., the lowest ul-powerControl-Id).

A second embodiment relates to multi-DCI based multi-TRP mode in multi-TRP scenario.

Multi-TRP based non-codebook PUSCH transmission with unified TCI framework will be specified in NR Release 18. Two SRS resource sets used for non-codebook can be configured in a BWP of a serving cell. In addition, two unified TCI states shall be indicated in the BWP of the serving cell.

In multi-DCI based multi-TRP mode, a higher layer parameter coresetPoolIndex is configured for each CORESET, which identifies a set of time frequency resources for PDCCH transmission, for TRP differential. In this mode, each TRP can independently transmit a DCI scheduling a PDSCH transmitted from the same TRP or a PUSCH transmitted to the same TRP. Each of the two SRS resource sets is associated with a coresetPoolIndex value. For example, the first SRS resource set is associated with coresetPoolIndex value 0 and the second SRS resource set is associated with coresetPoolIndex value 1. In addition, each of the two indicated unified TCI states is associated with a coresetPoolIndex value.

Each of the two indicated unified TCI states is associated with a PL-RS and may be further associated with an uplink power control parameter set (e.g., ul-powerControl).

When each of the two SRS resource sets for nCB is associated with an NZP CSI-RS resource, the UE shall determine the RS index q_{d} for obtaining the downlink pathloss estimate for SRS transmission corresponding to a SRS resource set based on the PL-RS associated with the indicated unified TCI state associated with the same coresetPoolIndex value as that associated with the SRS resource set. It means that the UE determines the RS index q_{d} for obtaining the downlink pathloss estimate for SRS transmission corresponding to a first SRS resource set based on the PL-RS associated with the indicated unified TCI state associated with the same coresetPoolIndex value, e.g., coresetPoolIndex value 0, as that associated with the first SRS resource set, and determines the RS index q_{d} for obtaining the downlink pathloss estimate for SRS transmission corresponding to a second SRS resource set based on the PL-RS associated with the indicated unified TCI state associated with the same coresetPoolIndex value, e.g., coresetPoolIndex value 1, as that associated with the second SRS resource set.

If the indicated unified TCI state is further associated with an uplink power control parameter set (e.g., ul-powerControl), the UE shall obtain P_{O_SRS,f,c}(qₛ), α_{SRS,b,f,c}(qₛ), and l corresponding to SRS transmission for an SRS resource set from the p0AlphaSetforSRS in the ul-powerControl associated with the indicated unified TCI state associated with the same coresetPoolIndex value as that associated with the SRS resource set. It means that the UE obtains P_{O_SRS,f,c}(qₛ), α_{SRS,b,f,c}(qₛ), and l corresponding to SRS transmission for a first SRS resource set from the p0AlphaSetforSRS in the ul-powerControl associated with the indicated unified TCI state associated with the same coresetPoolIndex value, e.g., coresetPoolIndex value 0, as that associated with the first SRS resource set, and obtains P_{O_SRS,f,c}(qₛ), α_{SRS,b,f,c}(qₛ), and l corresponding to SRS transmission for a second SRS resource set from the p0AlphaSetforSRS in the ul-powerControl associated with the indicated unified TCI state associated with the same coresetPoolIndex value, e.g., coresetPoolIndex value 0, as that associated with the second SRS resource set.

If the indicated unified TCI state is not associated with an uplink power control parameter set (e.g., ul-powerControl), a default ul-powerControl should be determined. The following options can be considered:

Option 2-1: if two dedicated ul-powerControls (e.g., a first ul-powerControl and a second ul-powerControl) are configured for the BWP of the serving cell and each ul-powerControl is associated with a coresetPoolIndex value (e.g., the first ul-powerControl is associated with coresetPoolIndex value 0 and the second ul-powerControl is associated with coresetPoolIndex value 1), the UE obtains the P_{O_SRS,f,c}(qₛ), α_{SRS,b,f,c}(qₛ), and l from the p0AlphaSetforSRS in the dedicated ul-powerControl associated with the same coresetPoolIndex value as the SRS resource set. It means that the UE obtains the P_{O_SRS,f,c}(qₛ), α_{SRS,b,f,c}(qₛ), and l for the SRS transmission corresponding to a first SRS resource set from the p0AlphaSetforSRS in the dedicated ul-powerControl associated with the same coresetPoolIndex value, e.g., coresetPoolIndex value 0, as the first SRS resource set, and obtains the P_{O_SRS,f,c}(qₛ), α_{SRS,b,f,c}(s), and l for the SRS transmission corresponding to a second SRS resource set from the p0AlphaSetforSRS in the dedicated ul-powerControl associated with the same coresetPoolIndex value, e.g., coresetPoolIndex value 1, as the second SRS resource set.

Option 2-2: if two ul-powerControl lists (e.g., a first ul-powerControl list and a second ul-powerControl list) are configured for the serving cell, and each list is associated with a coresetPoolIndex value (e.g., the first ul-powerControl list is associated with coresetPoolIndex value 0 and the second ul-powerControl list is associated with coresetPoolIndex value 1), the UE obtains the P_{O_SRS,f,c}(qₛ), α_{SRS,b,f,c}(qₛ), and l from the p0AlphaSetforSRS in the ul-powerControl with the lowest ul-powerControl-Id in the ul-powerControl list associated with the same coresetPoolIndex value as the SRS resource set. It means that the UE obtains the P_{O_SRS,f,c}(qₛ), α_{SRS,b,f,c}(qₛ), and l for the SRS transmission corresponding to a first SRS resource set from the p0AlphaSetforSRS in the ul-powerControl with the lowest ul-powerControl-Id in the ul-powerControl list (e.g., the first ul-powerControl list) associated with the same coresetPoolIndex value, e.g., coresetPoolIndex value 0, as the first SRS resource set, and obtains the P_{O_SRS,f,c}(qₛ), α_{SRS,b,f,c}(qₛ), and l for the SRS transmission corresponding to a second SRS resource set from the p0AlphaSetforSRS in the ul-powerControl with the lowest ul-powerControl-Id in the ul-powerControl list (e.g., the second ul-powerControl list) associated with the same coresetPoolIndex value, e.g., coresetPoolIndex value 1, as the second SRS resource set.

Option 2-3: if only one ul-powerControl list is configured for the serving cell, the UE obtains the P_{O_SRS,f,c}(qₛ), α_{SRS,b,f,c}(qₛ), and l from the p0AlphaSetforSRS in the ul-powerControl with the lowest ul-powerControl-Id and with the second lowest ul-powerControl-Id for the first and the second SRS resource sets, respectively. The first and the second SRS resource sets correspond to the SRS resource set associated with coresetPoolIndex=0 and coresetPoolIndex=1, respectively. It means that the UE obtains the P_{O_SRS,f,c}(qₛ), α_{SRS,b,f,c}(qₛ), and l for the SRS transmission corresponding to a first SRS resource set from the p0AlphaSetforSRS in the ul-powerControl with the lowest ul-powerControl-Id in the ul-powerControl list, and obtains the P_{O_SRS,f,c}(qₛ), α_{SRS,b,f,c}(qₛ), and l for the SRS transmission corresponding to a second SRS resource set from the p0AlphaSetforSRS in the ul-powerControl with the second lowest ul-powerControl-Id in the ul-powerControl list.

A third embodiment relates to single-DCI based multi-TRP mode in multi-TRP scenario.

In single-DCI based multi-TRP mode, coresetPoolIndex shall not be configured. In this mode, one TRP may transmit a DCI scheduling a PDSCH transmitted from both TRPs. Each of the two SRS resource sets is associated with one of the two indicated unified TCI states in a fixed manner. For example, suppose that the two SRS resource sets are a first SRS resource set (e.g., the SRS resource set with a lower SRS resource set ID) and a second SRS resource set (e.g., the SRS resource set with a higher SRS resource set ID), and that the two indicated unified TCI states are a first indicated unified TCI state and a second indicated unified TCI state, the first SRS resource set is associated with the first indicated unified TCI state and the second SRS resource set is associated with the second indicated unified TCI state.

Each of the first indicated unified TCI state and the second indicated unified TCI state is associated with a PL-RS and may be further associated with an uplink power control parameter set (e.g., ul-powerControl).

When each of the first SRS resource set for nCB and the second SRS resource set for nCB is associated with an NZP CSI-RS resource (e.g., the first SRS resource set for nCB is associated with a first NZP CSI-RS resource and the second SRS resource set for nCB is associated with a second NZP CSI-RS resource), the UE shall determine the RS index q_{d} for obtaining the downlink pathloss estimate for SRS transmission corresponding to each SRS resource set based on the PL-RS associated with the indicated unified TCI state associated with the SRS resource set. For example, the UE shall determine the RS index q_{d} for obtaining the downlink pathloss estimate for SRS transmission corresponding to a first SRS resource set based on the PL-RS associated with the first indicated unified TCI state associated with the first SRS resource set, and determine the RS index q_{d} for obtaining the downlink pathloss estimate for SRS transmission corresponding to a second SRS resource set based on the PL-RS associated with the second indicated unified TCI state associated with the second SRS resource set.

If the indicated unified TCI state (the first indicated unified TCI state or the second indicated unified TCI state) is further associated with an uplink power control parameter set (e.g., ul-powerControl), the UE shall obtain P_{O_SRS,f,c}(qₛ), α_{SRS,b,f,c}(qₛ), and l corresponding to SRS transmission for an SRS resource set from the p0AlphaSetforSRS in the ul-powerControl associated with the indicated unified TCI state associated with the SRS resource set. It means that the UE obtains P_{O_SRS,f,c}(qₛ), α_{SRS,b,f,c}(qₛ), and l corresponding to SRS transmission for a first SRS resource set from the p0AlphaSetforSRS in the ul-powerControl associated with the indicated unified TCI state (e.g., the first indicated unified TCI state) associated with the first SRS resource set, and obtains P_{O_SRS,f,c}(qₛ), α_{SRS,b,f,c}(qₛ), and l corresponding to SRS transmission for a second SRS resource set from the p0AlphaSetforSRS in the ul-powerControl associated with the indicated unified TCI state (e.g., the second indicated unified TCI state) associated with the second SRS resource set.

If the indicated unified TCI state is not associated with an uplink power control parameter set (e.g., ul-powerControl), a default ul-powerControl should be determined. The following options can be considered:

Option 3-1: if two dedicated ul-powerControls (e.g., a first ul-powerControl and a second ul-powerControl) are configured for the BWP of the serving cell, the UE determines the P_{O_SRS,f,c}(qₛ), α_{SRS,b,f,c}(qₛ), and l for the SRS transmission corresponding to the first SRS resource set from the p0AlphaSetforSRS in the first ul-powerControl, and determines the P_{O_SRS,f,c}(qₛ), α_{SRS,b,f,c}(qₛ), and l for the SRS transmission corresponding to the second SRS resource set from the p0AlphaSetforSRS in the second ul-powerControl.

Option 3-2: if two ul-powerControl lists (e.g., a first ul-powerControl list and a second ul-powerControl list) are configured for the serving cell, the UE determines the P_{O_SRS,f,c}(qₛ), α_{SRS,b,f,c}(qₛ), and l for the SRS transmission corresponding to the first SRS resource set from the p0AlphaSetforSRS in the first ul-powerControl list with the lowest ul-powerControl-Id, and determines the P_{O_SRS,f,c}(qₛ), α_{SRS,b,f,c}(qₛ), and l for the SRS transmission corresponding to the second SRS resource set from the p0AlphaSetforSRS in the second ul-powerControl list with the lowest ul-powerControl-Id.

Option 3-3: if only one ul-powerControl list is configured for the serving cell, the UE determines the P_{O_SRS,f,c}(qₛ), α_{SRS,b,f,c}(qₛ), and l corresponding to the first SRS resource set from the p0AlphaSetforSRS in the ul-powerControl list with the lowest ul-powerControl-Id, and determines the P_{O_SRS,f,c}(qₛ), α_{SRS,b,f,c}(qₛ), and l corresponding to the second SRS resource set from the p0AlphaSetforSRS in the ul-powerControl list with the second lowest ul-powerControl-Id.

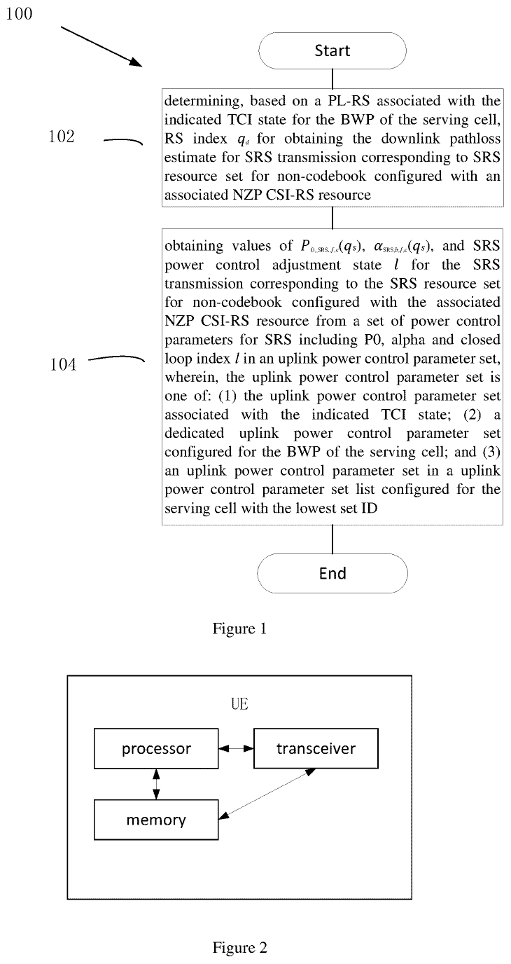

FIG. 1 is a schematic flow chart diagram illustrating an embodiment of a method 100 according to the present application. In some embodiments, the method 100 is performed by an apparatus, such as a remote unit (e.g., UE). In certain embodiments, the method 100 may be performed by a processor executing program code, for example, a microcontroller, a microprocessor, a CPU, a GPU, an auxiliary processing unit, a FPGA, or the like.

The method 100 is a method performed at a UE, wherein, a TCI state is indicated for a BWP of a serving cell, the method comprising: 102 determining, based on a PL-RS associated with the indicated TCI state for the BWP of the serving cell, RS index q_{d} for obtaining the downlink pathloss estimate for SRS transmission corresponding to SRS resource set for non-codebook configured with an associated NZP CSI-RS resource; and 104 obtaining values of P_{O_SRS,f,c}(qₛ), α_{SRS,b,f,c}(qₛ), and SRS power control adjustment state l for the SRS transmission corresponding to the SRS resource set for non-codebook configured with the associated NZP CSI-RS resource from a set of power control parameters for SRS including P0, alpha and closed loop index l in an uplink power control parameter set, wherein, the uplink power control parameter set is one of: (1) the uplink power control parameter set associated with the indicated TCI state; (2) a dedicated uplink power control parameter set configured for the BWP of the serving cell; and (3) an uplink power control parameter set in a uplink power control parameter set list configured for the serving cell with the lowest set ID.

In some embodiment, two TCI states including a first TCI state and a second TCI state are indicated for the BWP of the serving cell, and wherein, the method comprising: determining, based on a PL-RS associated with the first indicated TCI state for the BWP of the serving cell, RS index q_{d} for obtaining the downlink pathloss estimate for SRS transmission corresponding to a first SRS resource set for non-codebook configured with a first associated NZP CSI-RS resource, and determining, based on a PL-RS associated with the second indicated TCI state for the BWP of the serving cell, RS index q_{d} for obtaining the downlink pathloss estimate for SRS transmission corresponding to a second SRS resource set for non-codebook configured with a second associated NZP CSI-RS resource; and obtaining values of P_{O_SRS,f,c}(qₛ), α_{SRS,b,f,c}(qₛ), and SRS power control adjustment state l for the SRS transmission corresponding to the first SRS resource set for non-codebook configured with the first associated NZP CSI-RS resource from a first set of power control parameters for SRS including P0, alpha and closed loop index l in a first uplink power control parameter set, and obtaining values of P_{O_SRS,f,c}(qₛ), α_{SRS,b,f,c}(s), and SRS power control adjustment state l for the SRS transmission corresponding to the second SRS resource set for non-codebook configured with the second associated NZP CSI-RS resource from a second set of power control parameters for SRS including P0, alpha and closed loop index l in a second uplink power control parameter set, wherein, the first uplink power control parameter set and the second uplink power control parameter set are one of: (1) the uplink power control parameter set associated with the first indicated TCI state and the uplink power control parameter set associated with the second indicated TCI state; (2) a first dedicated uplink power control parameter set configured for the BWP of the serving cell and a second dedicated uplink power control parameter set configured for the BWP of the serving cell; (3) an uplink power control parameter set in a first uplink power control parameter set list configured for the serving cell with the lowest set ID and an uplink power control parameter set in a second uplink power control parameter set list configured for the serving cell with the lowest set ID; and (4) an uplink power control parameter set in an uplink power control parameter set list configured for the serving cell with the lowest set ID and an uplink power control parameter set in the uplink power control parameter set list configured for the serving cell with the second lowest set ID.

In some embodiment, two TCI states each of which is associated with a coresetPoolIndex value are indicated for the BWP of the serving cell, and wherein, the method comprising: determining RS index q_{d} for obtaining the downlink pathloss estimate for SRS transmission corresponding to a first SRS resource set for non-codebook configured with a first associated NZP CSI-RS resource, based on a PL-RS associated with one indicated TCI state associated with the same coresetPoolIndex value as that associated with the first SRS resource set for non-codebook, and determining RS index q_{d} for obtaining the downlink pathloss estimate for SRS transmission corresponding to a second SRS resource set for non-codebook configured with a second associated NZP CSI-RS resource, based on a PL-RS associated with one indicated TCI state associated with the same coresetPoolIndex value as that associated with the second SRS resource set for non-codebook; and obtaining values of P_{O_SRS,f,c}(qₛ), α_{SRS,b,f,c}(qₛ), and SRS power control adjustment state l for the SRS transmission corresponding to the first SRS resource set for non-codebook configured with the first associated NZP CSI-RS resource from a first set of power control parameters for SRS including P0, alpha and closed loop index l in a first uplink power control parameter set, and obtaining values of P_{O_SRS,f,c}(qₛ), α_{SRS,b,f,c}(qₛ), and SRS power control adjustment state l for the SRS transmission corresponding to the second SRS resource set for non-codebook configured with the second associated NZP CSI-RS resource from a second set of power control parameters for SRS including P0, alpha and closed loop index l in a second uplink power control parameter set, wherein, the first uplink power control parameter set and the second uplink power control parameter set are one of: (1) the uplink power control parameter set associated with one indicated TCI state that is associated with the same coresetPoolIndex value as that associated with the first SRS resource set and the uplink power control parameter set associated with one indicated TCI state that is associated with the same coresetPoolIndex value as that associated with the second SRS resource set; (2) a first dedicated uplink power control parameter set configured for the BWP of the serving cell associated with the same coresetPoolIndex value as that associated with the first SRS resource set and a second dedicated uplink power control parameter set configured for the BWP of the serving cell associated with the same coresetPoolIndex value as that associated with the second SRS resource set; (3) an uplink power control parameter set in a first uplink power control parameter set list configured for the serving cell that is associated with the same coresetPoolIndex value as that associated with the first SRS resource set with the lowest set ID and an uplink power control parameter set in a second uplink power control parameter set list configured for the serving cell that is associated with the same coresetPoolIndex value as that associated with the second SRS resource set with the lowest set ID; and (4) an uplink power control parameter set in an uplink power control parameter set list configured for the serving cell with the lowest set ID and an uplink power control parameter set in the uplink power control parameter set list configured for the serving cell with the second lowest set ID.

FIG. 2 is a schematic block diagram illustrating apparatus according to one embodiment.

Referring to FIG. 2, the UE (i.e., the remote unit) includes a processor, a memory, and a transceiver. The processor implements a function, a process, and/or a method which are proposed in FIG. 1.

The UE comprises a transceiver; and a processor coupled to the transceiver, wherein, a TCI state is indicated for a BWP of a serving cell, and wherein the processor is configured to determine, based on a PL-RS associated with the indicated TCI state for the BWP of the serving cell, RS index q_{d} for obtaining the downlink pathloss estimate for SRS transmission corresponding to SRS resource set for non-codebook configured with an associated NZP CSI-RS resource; and obtain values of P_{O_SRS,f,c}(qₛ), α_{SRS,b,f,c}(qₛ), and SRS power control adjustment state l for the SRS transmission corresponding to the SRS resource set for non-codebook configured with the associated NZP CSI-RS resource from a set of power control parameters for SRS including P0, alpha and closed loop index l in an uplink power control parameter set, wherein, the uplink power control parameter set is one of: (1) the uplink power control parameter set associated with the indicated TCI state; (2) a dedicated uplink power control parameter set configured for the BWP of the serving cell; and (3) an uplink power control parameter set in a uplink power control parameter set list configured for the serving cell with the lowest set ID.

In some embodiment, two TCI states including a first TCI state and a second TCI state are indicated for the BWP of the serving cell, and wherein, the processor is configured to determine, based on a PL-RS associated with the first indicated TCI state for the BWP of the serving cell, RS index q_{d} for obtaining the downlink pathloss estimate for SRS transmission corresponding to a first SRS resource set for non-codebook configured with a first associated NZP CSI-RS resource, and determine, based on a PL-RS associated with the second indicated TCI state for the BWP of the serving cell, RS index q_{d} for obtaining the downlink pathloss estimate for SRS transmission corresponding to a second SRS resource set for non-codebook configured with a second associated NZP CSI-RS resource; and obtain values of P_{O_SRS,f,c}(qₛ), α_{SRS,b,f,c}(qₛ), and SRS power control adjustment state l for the SRS transmission corresponding to the first SRS resource set for non-codebook configured with the first associated NZP CSI-RS resource from a first set of power control parameters for SRS including P0, alpha and closed loop index/in a first uplink power control parameter set, and obtain values of P_{O_SRS,f,c}(qₛ), α_{SRS,b,f,c}(qₛ), and SRS power control adjustment state l for the SRS transmission corresponding to the second SRS resource set for non-codebook configured with the second associated NZP CSI-RS resource from a second set of power control parameters for SRS including P0, alpha and closed loop index l in a second uplink power control parameter set, wherein, the first uplink power control parameter set and the second uplink power control parameter set are one of: (1) the uplink power control parameter set associated with the first indicated TCI state and the uplink power control parameter set associated with the second indicated TCI state; (2) a first dedicated uplink power control parameter set configured for the BWP of the serving cell and a second dedicated uplink power control parameter set configured for the BWP of the serving cell; (3) an uplink power control parameter set in a first uplink power control parameter set list configured for the serving cell with the lowest set ID and an uplink power control parameter set in a second uplink power control parameter set list configured for the serving cell with the lowest set ID; and (4) an uplink power control parameter set in an uplink power control parameter set list configured for the serving cell with the lowest set ID and an uplink power control parameter set in the uplink power control parameter set list configured for the serving cell with the second lowest set ID.

In some embodiment, two TCI states each of which is associated with a coresetPoolIndex value are indicated for the BWP of the serving cell, and wherein, the processor is configured to determine RS index q_{d} for obtaining the downlink pathloss estimate for SRS transmission corresponding to a first SRS resource set for non-codebook configured with a first associated NZP CSI-RS resource, based on a PL-RS associated with one indicated TCI state associated with the same coresetPoolIndex value as that associated with the first SRS resource set for non-codebook, and determine RS index q_{d} for obtaining the downlink pathloss estimate for SRS transmission corresponding to a second SRS resource set for non-codebook configured with a second associated NZP CSI-RS resource, based on a PL-RS associated with one indicated TCI state associated with the same coresetPoolIndex value as that associated with the second SRS resource set for non-codebook; and obtain values of P_{O_SRS,f,c}(qₛ), α_{SRS,b,f,c}(qₛ), and SRS power control adjustment state l for the SRS transmission corresponding to the first SRS resource set for non-codebook configured with the first associated NZP CSI-RS resource from a first set of power control parameters for SRS including P0, alpha and closed loop index l in a first uplink power control parameter set, and obtain values of P_{O_SRS,f,c}(qₛ), α_{SRS,b,f,c}(qₛ), and SRS power control adjustment state l for the SRS transmission corresponding to the second SRS resource set for non-codebook configured with the second associated NZP CSI-RS resource from a second set of power control parameters for SRS including P0, alpha and closed loop index/in a second uplink power control parameter set, wherein, the first uplink power control parameter set and the second uplink power control parameter set are one of: (1) the uplink power control parameter set associated with one indicated TCI state that is associated with the same coresetPoolIndex value as that associated with the first SRS resource set and the uplink power control parameter set associated with one indicated TCI state that is associated with the same coresetPoolIndex value as that associated with the second SRS resource set; (2) a first dedicated uplink power control parameter set configured for the BWP of the serving cell associated with the same coresetPoolIndex value as that associated with the first SRS resource set and a second dedicated uplink power control parameter set configured for the BWP of the serving cell associated with the same coresetPoolIndex value as that associated with the second SRS resource set; (3) an uplink power control parameter set in a first uplink power control parameter set list configured for the serving cell that is associated with the same coresetPoolIndex value as that associated with the first SRS resource set with the lowest set ID and an uplink power control parameter set in a second uplink power control parameter set list configured for the serving cell that is associated with the same coresetPoolIndex value as that associated with the second SRS resource set with the lowest set ID; and (4) an uplink power control parameter set in an uplink power control parameter set list configured for the serving cell with the lowest set ID and an uplink power control parameter set in the uplink power control parameter set list configured for the serving cell with the second lowest set ID.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated in the appended claims rather than by the foregoing description. All changes which come within the meaning and range of equivalency of the claims are to be embraced within their scope.

1. A user equipment (UE) for wireless communication, comprising:
at least one memory; and
at least one processor coupled with the at least one memory and configured to cause the UE to:
determine, based on a path loss reference signal (PL-RS) associated with at least one of a transmission configuration indication (TCI) state for a bandwidth part (BWP) of a serving cell, and a reference signal (RS) index for obtaining a downlink pathloss estimate for a sounding reference signal (SRS) transmission corresponding to a SRS resource set for non-codebook configured with an associated non-zero power (NZP) channel state information reference signal (CSI-RS) resource; and
obtain parameter values from a set of power control parameters for SRS and a SRS power control adjustment state for the SRS transmission corresponding to the SRS resource set for non-codebook configured with the associated NZP CSI-RS resource in an uplink power control parameter set, wherein the uplink power control parameter set is one of associated with the TCI state, a dedicated uplink power control parameter set configured for the BWP of the serving cell, or an uplink power control parameter set in an uplink power control parameter set list configured for the serving cell with a lowest set ID.

2. The UE of claim 1, wherein two TCI states including a first TCI state and a second TCI state are indicated for the BWP of the serving cell, and the at least one processor is configured to cause the UE to:
determine, based on a PL-RS associated with the first TCI state for the BWP of the serving cell, the RS index for obtaining the downlink pathloss estimate for the SRS transmission corresponding to a first SRS resource set for non-codebook configured with a first associated NZP CSI-RS resource;
determine, based on a PL-RS associated with the second TCI state for the BWP of the serving cell, the RS index for obtaining the downlink pathloss estimate for the SRS transmission corresponding to a second SRS resource set for non-codebook configured with a second associated NZP CSI-RS resource;
obtain the parameter values from a first set of power control parameters for SRS and the SRS power control adjustment state for the SRS transmission corresponding to the first SRS resource set for non-codebook configured with the first associated NZP CSI-RS resource in a first uplink power control parameter set; and
obtain the parameter values from a second set of power control parameters for SRS and the SRS power control adjustment state for the SRS transmission corresponding to the second SRS resource set for non-codebook configured with the second associated NZP CSI-RS resource in a second uplink power control parameter set.

3. The UE of claim 1, wherein two TCI states each associated with a coresetPoolIndex value are indicated for the BWP of the serving cell, and the at least one processor is configured to cause the UE to:
determine the RS index for obtaining the downlink pathloss estimate for the SRS transmission corresponding to a first SRS resource set for non-codebook configured with a first associated NZP CSI-RS resource, based on a PL-RS associated with one indicated TCI state associated with a same coresetPoolIndex value as that associated with the first SRS resource set for non-codebook;
determine the RS index for obtaining the downlink pathloss estimate for the SRS transmission corresponding to a second SRS resource set for non-codebook configured with a second associated NZP CSI-RS resource, based on a PL-RS associated with one indicated TCI state associated with the same coresetPoolIndex value as that associated with the second SRS resource set for non-codebook;
obtain the parameter values from a first set of power control parameters for SRS and the SRS power control adjustment state for the SRS transmission corresponding to the first SRS resource set for non-codebook configured with the first associated NZP CSI-RS resource in a first uplink power control parameter set; and
obtain the parameter values from a second set of power control parameters for SRS and SRS power control adjustment state for the SRS transmission corresponding to the second SRS resource set for non-codebook configured with the second associated NZP CSI-RS resource in a second uplink power control parameter set.

4. A method performed by a user equipment (UE), the method comprising:
determining, based on a path loss reference signal (PL-RS) associated with at least one of a transmission configuration indication (TCI) state for a bandwidth part (BWP) of a serving cell, and a reference signal (RS) index for obtaining a downlink pathloss estimate for a sounding reference signal (SRS) transmission corresponding to a SRS resource set for non-codebook configured with an associated non-zero power (NZP) channel state information reference signal (CSI-RS) resource; and
obtaining parameter values from a set of power control parameters for SRS and a SRS power control adjustment state for the SRS transmission corresponding to the SRS resource set for non-codebook configured with the associated NZP CSI-RS resource in an uplink power control parameter set, wherein the uplink power control parameter set is one of associated with the TCI state, a dedicated uplink power control parameter set configured for the BWP of the serving cell, or an uplink power control parameter set in an uplink power control parameter set list configured for the serving cell with a lowest set ID.

5. The method of claim 4, wherein two TCI states including a first TCI state and a second TCI state are indicated for the BWP of the serving cell, and the method further comprising:
determining, based on a PL-RS associated with the first TCI state for the BWP of the serving cell, the RS index for obtaining the downlink pathloss estimate for the SRS transmission corresponding to a first SRS resource set for non-codebook configured with a first associated NZP CSI-RS resource;
determining, based on a PL-RS associated with the second TCI state for the BWP of the serving cell, the RS index for obtaining the downlink pathloss estimate for the SRS transmission corresponding to a second SRS resource set for non-codebook configured with a second associated NZP CSI-RS resource;
obtaining the parameter values from a first set of power control parameters for SRS and the SRS power control adjustment state for the SRS transmission corresponding to the first SRS resource set for non-codebook configured with the first associated NZP CSI-RS resource in a first uplink power control parameter set; and
obtaining the parameter values from a second set of power control parameters for SRS and the SRS power control adjustment state for the SRS transmission corresponding to the second SRS resource set for non-codebook configured with the second associated NZP CSI-RS resource in a second uplink power control parameter set.

6. The method of claim 4, wherein two TCI states each associated with a coresetPoolIndex value are indicated for the BWP of the serving cell, and the method further comprising:
determining the RS index for obtaining the downlink pathloss estimate for the SRS transmission corresponding to a first SRS resource set for non-codebook configured with a first associated NZP CSI-RS resource, based on a PL-RS associated with one indicated TCI state associated with a same coresetPoolIndex value as that associated with the first SRS resource set for non-codebook;
determining the RS index for obtaining the downlink pathloss estimate for the SRS transmission corresponding to a second SRS resource set for non-codebook configured with a second associated NZP CSI-RS resource, based on a PL-RS associated with one indicated TCI state associated with the same coresetPoolIndex value as that associated with the second SRS resource set for non-codebook;
obtaining the parameter values from a first set of power control parameters for SRS and the SRS power control adjustment state for the SRS transmission corresponding to the first SRS resource set for non-codebook configured with the first associated NZP CSI-RS resource in a first uplink power control parameter set; and
obtaining the parameter values from a second set of power control parameters for SRS and SRS power control adjustment state for the SRS transmission corresponding to the second SRS resource set for non-codebook configured with the second associated NZP CSI-RS resource in a second uplink power control parameter set.

7. The UE of claim 2, wherein the first uplink power control parameter set and the second uplink power control parameter set are one of:
the uplink power control parameter set associated with the first TCI state and the uplink power control parameter set associated with the second TCI state;
a first dedicated uplink power control parameter set configured for the BWP of the serving cell and a second dedicated uplink power control parameter set configured for the BWP of the serving cell;
an uplink power control parameter set in a first uplink power control parameter set list configured for the serving cell with a lowest set ID and an uplink power control parameter set in a second uplink power control parameter set list configured for the serving cell with the lowest set ID; or
an uplink power control parameter set in an uplink power control parameter set list configured for the serving cell with the lowest set ID and an uplink power control parameter set in the uplink power control parameter set list configured for the serving cell with a second lowest set ID.

8. The UE of claim 3, wherein the first uplink power control parameter set and the second uplink power control parameter set are one of:
the uplink power control parameter set associated with a first one TCI state that is associated with the same coresetPoolIndex value as that associated with the first SRS resource set and the uplink power control parameter set associated with a second one TCI state that is associated with the same coresetPoolIndex value as that associated with the second SRS resource set;
a first dedicated uplink power control parameter set configured for the BWP of the serving cell associated with the same coresetPoolIndex value as that associated with the first SRS resource set and a second dedicated uplink power control parameter set configured for the BWP of the serving cell associated with the same coresetPoolIndex value as that associated with the second SRS resource set;
an uplink power control parameter set in a first uplink power control parameter set list configured for the serving cell that is associated with the same coresetPoolIndex value as that associated with the first SRS resource set with a lowest set ID and an uplink power control parameter set in a second uplink power control parameter set list configured for the serving cell that is associated with the same coresetPoolIndex value as that associated with the second SRS resource set with a lowest set ID; or
an uplink power control parameter set in an uplink power control parameter set list configured for the serving cell with the lowest set ID and an uplink power control parameter set in the uplink power control parameter set list configured for the serving cell with a second lowest set ID.

9. The method of claim 5, wherein the first uplink power control parameter set and the second uplink power control parameter set are one of:
the uplink power control parameter set associated with the first TCI state and the uplink power control parameter set associated with the second TCI state;
a first dedicated uplink power control parameter set configured for the BWP of the serving cell and a second dedicated uplink power control parameter set configured for the BWP of the serving cell;
an uplink power control parameter set in a first uplink power control parameter set list configured for the serving cell with a lowest set ID and an uplink power control parameter set in a second uplink power control parameter set list configured for the serving cell with the lowest set ID; or
an uplink power control parameter set in an uplink power control parameter set list configured for the serving cell with the lowest set ID and an uplink power control parameter set in the uplink power control parameter set list configured for the serving cell with a second lowest set ID.

10. The method of claim 6, wherein the first uplink power control parameter set and the second uplink power control parameter set are one of:
the uplink power control parameter set associated with a first one TCI state that is associated with the same coresetPoolIndex value as that associated with the first SRS resource set and the uplink power control parameter set associated with a second one TCI state that is associated with the same coresetPoolIndex value as that associated with the second SRS resource set;
a first dedicated uplink power control parameter set configured for the BWP of the serving cell associated with the same coresetPoolIndex value as that associated with the first SRS resource set and a second dedicated uplink power control parameter set configured for the BWP of the serving cell associated with the same coresetPoolIndex value as that associated with the second SRS resource set;
an uplink power control parameter set in a first uplink power control parameter set list configured for the serving cell that is associated with the same coresetPoolIndex value as that associated with the first SRS resource set with a lowest set ID and an uplink power control parameter set in a second uplink power control parameter set list configured for the serving cell that is associated with the same coresetPoolIndex value as that associated with the second SRS resource set with a lowest set ID; or
an uplink power control parameter set in an uplink power control parameter set list configured for the serving cell with the lowest set ID and an uplink power control parameter set in the uplink power control parameter set list configured for the serving cell with a second lowest set ID.

11. The UE of claim 1, wherein if the set of power control parameters for SRS is not associated with the TCI state and if a dedicated uplink power control parameter set ul-powerControl is configured for the BWP of the serving cell, then the at least one processor is configured to cause the UE to obtain a parameter value of the set of power control parameters for SRS and the SRS power control adjustment state for the SRS transmission corresponding to SRS resource set for non-codebook with associated CSI-RS in p0AlphaSetforSRS contained in the dedicated uplink power control parameter set ul-powerControl.

12. The UE of claim 1, wherein if the set of power control parameters for SRS is not associated with the TCI state and if an ul-powerControl list is configured for the serving cell, then the at least one processor is configured to cause the UE to obtain a parameter value of the set of power control parameters for SRS and the SRS power control adjustment state for the SRS transmission corresponding to SRS resource set for non-codebook with associated CSI-RS in p0AlphaSetforSRS contained in an ul-powerControl with a lowest ul-powerControl-Id.

13. The method of claim 4, wherein if the set of power control parameters for SRS is not associated with the TCI state and if a dedicated uplink power control parameter set ul-powerControl is configured for the BWP of the serving cell, then the method further comprising obtaining a parameter value of the set of power control parameters for SRS and the SRS power control adjustment state for the SRS transmission corresponding to SRS resource set for non-codebook with associated CSI-RS in p0AlphaSetforSRS contained in the dedicated uplink power control parameter set ul-powerControl.

14. The method of claim 4, wherein if the set of power control parameters for SRS is not associated with the TCI state and if an ul-powerControl list is configured for the serving cell, then the method further comprising obtaining a parameter value of the set of power control parameters for SRS and the SRS power control adjustment state for the SRS transmission corresponding to SRS resource set for non-codebook with associated CSI-RS in p0AlphaSetforSRS contained in an ul-powerControl with a lowest ul-powerControl-Id.

15. A processor for wireless communication, comprising:
at least one controller coupled with at least one memory and configured to cause the processor to:
determine, based on a path loss reference signal (PL-RS) associated with at least one of a transmission configuration indication (TCI) state for a bandwidth part (BWP) of a serving cell, and a reference signal (RS) index for obtaining a downlink pathloss estimate for a sounding reference signal (SRS) transmission corresponding to a SRS resource set for non-codebook configured with an associated non-zero power (NZP) channel state information reference signal (CSI-RS) resource; and
obtain parameter values from a set of power control parameters for SRS and a SRS power control adjustment state for the SRS transmission corresponding to the SRS resource set for non-codebook configured with the associated NZP CSI-RS resource in an uplink power control parameter set, wherein the uplink power control parameter set is one of associated with the TCI state, a dedicated uplink power control parameter set configured for the BWP of the serving cell, or an uplink power control parameter set in an uplink power control parameter set list configured for the serving cell with a lowest set ID.

16. The processor of claim 15, wherein two TCI states including a first TCI state and a second TCI state are indicated for the BWP of the serving cell, and the at least one controller is configured to cause the processor to:
determine, based on a PL-RS associated with the first TCI state for the BWP of the serving cell, the RS index for obtaining the downlink pathloss estimate for the SRS transmission corresponding to a first SRS resource set for non-codebook configured with a first associated NZP CSI-RS resource;
determine, based on a PL-RS associated with the second TCI state for the BWP of the serving cell, the RS index for obtaining the downlink pathloss estimate for the SRS transmission corresponding to a second SRS resource set for non-codebook configured with a second associated NZP CSI-RS resource;
obtain the parameter values from a first set of power control parameters for SRS and the SRS power control adjustment state for the SRS transmission corresponding to the first SRS resource set for non-codebook configured with the first associated NZP CSI-RS resource in a first uplink power control parameter set; and
obtain the parameter values from a second set of power control parameters for SRS and the SRS power control adjustment state for the SRS transmission corresponding to the second SRS resource set for non-codebook configured with the second associated NZP CSI-RS resource in a second uplink power control parameter set.

17. The processor of claim 16, wherein the first uplink power control parameter set and the second uplink power control parameter set are one of:
the uplink power control parameter set associated with the first TCI state and the uplink power control parameter set associated with the second TCI state;
a first dedicated uplink power control parameter set configured for the BWP of the serving cell and a second dedicated uplink power control parameter set configured for the BWP of the serving cell;
an uplink power control parameter set in a first uplink power control parameter set list configured for the serving cell with a lowest set ID and an uplink power control parameter set in a second uplink power control parameter set list configured for the serving cell with the lowest set ID; or
an uplink power control parameter set in an uplink power control parameter set list configured for the serving cell with the lowest set ID and an uplink power control parameter set in the uplink power control parameter set list configured for the serving cell with a second lowest set ID.

18. The processor of claim 15, wherein two TCI states each associated with a coresetPoolIndex value are indicated for the BWP of the serving cell, and the at least one controller is configured to cause the processor to:
determine the RS index for obtaining the downlink pathloss estimate for the SRS transmission corresponding to a first SRS resource set for non-codebook configured with a first associated NZP CSI-RS resource, based on a PL-RS associated with one indicated TCI state associated with a same coresetPoolIndex value as that associated with the first SRS resource set for non-codebook;
determine the RS index for obtaining the downlink pathloss estimate for the SRS transmission corresponding to a second SRS resource set for non-codebook configured with a second associated NZP CSI-RS resource, based on a PL-RS associated with one indicated TCI state associated with the same coresetPoolIndex value as that associated with the second SRS resource set for non-codebook;
obtain the parameter values from a first set of power control parameters for SRS and the SRS power control adjustment state for the SRS transmission corresponding to the first SRS resource set for non-codebook configured with the first associated NZP CSI-RS resource in a first uplink power control parameter set; and
obtain the parameter values from a second set of power control parameters for SRS and SRS power control adjustment state for the SRS transmission corresponding to the second SRS resource set for non-codebook configured with the second associated NZP CSI-RS resource in a second uplink power control parameter set.

19. The processor of claim 18, wherein the first uplink power control parameter set and the second uplink power control parameter set are one of:
the uplink power control parameter set associated with a first one TCI state that is associated with the same coresetPoolIndex value as that associated with the first SRS resource set and the uplink power control parameter set associated with a second one TCI state that is associated with the same coresetPoolIndex value as that associated with the second SRS resource set;
a first dedicated uplink power control parameter set configured for the BWP of the serving cell associated with the same coresetPoolIndex value as that associated with the first SRS resource set and a second dedicated uplink power control parameter set configured for the BWP of the serving cell associated with the same coresetPoolIndex value as that associated with the second SRS resource set;
an uplink power control parameter set in a first uplink power control parameter set list configured for the serving cell that is associated with the same coresetPoolIndex value as that associated with the first SRS resource set with a lowest set ID and an uplink power control parameter set in a second uplink power control parameter set list configured for the serving cell that is associated with the same coresetPoolIndex value as that associated with the second SRS resource set with a lowest set ID; or
an uplink power control parameter set in an uplink power control parameter set list configured for the serving cell with the lowest set ID and an uplink power control parameter set in the uplink power control parameter set list configured for the serving cell with a second lowest set ID.

20. The processor of claim 15, wherein if the set of power control parameters for SRS is not associated with the TCI state and if a dedicated uplink power control parameter set ul-powerControl is configured for the BWP of the serving cell, then the at least one controller is configured to cause the processor to obtain a parameter value of the set of power control parameters for SRS and the SRS power control adjustment state for the SRS transmission corresponding to SRS resource set for non-codebook with associated CSI-RS in p0AlphaSetforSRS contained in the dedicated uplink power control parameter set ul-powerControl.
